(19) United States
(12) Patent Application Publication
(10) Pub. No.: US 2003/0020691 A1
(43) Pub. Date: Jan. 30, 2003

(54) Keyboard with expanded function

(76) Inventors: Jung-Chuan Pan, Taipei Hsien (TW); Jay Terng, Taipei (TW)

Correspondence Address: RABIN & BERDO, P.C., Suite 500, 1101 14 Street, N.W., Washington, DC, 20005, US

(21) Appl. No.: 09/912,396

(22) Filed: Jul. 26, 2001

(51) Int. Cl. G09G 5/00

(52) U.S. Cl. 345/168

(57) ABSTRACT

A keyboard is integrated with peripheral or the personal article to provide expanded function. The peripheral can be card reader, loud speaker, wireless receiver, IR receiver, charger, fingerprint reader, video/audio acquisition means, handset port or PDA port. The personal article can be a radio, a clock or a photo frame. The keyboard with expanded function can enhance convenience and provide tidiness.

### FIELD OF THE INVENTION

The present invention relates to a keyboard with expanded function, especially to a keyboard with expanded function for other computer peripheral and personal articles.

### BACKGROUND OF THE INVENTION

The conventional computers are generally equipped with peripheral peculiarly for data input. As the advance and versatility of computer, various peripherals such as card reader, loud speaker, wireless receiver, IR receiver, charger, fingerprint reader, video/audio acquisition means, handset port and PDA port are integrated to the computer for providing flexible functions.

As to the conventional peripherals for computer, the keyboard is relatively indispensable and often used to replace the function of other peripheral such as mouse and joystick. Therefore, it is advantageous to exploit the full usage of keyboard for providing more flexible function.

### SUMMARY OF THE INVENTION

It is the object of the present invention to provide a keyboard with expanded function for other computer peripheral and personal article, thereby providing enhanced convenience and tidiness.

To achieve above object, the present invention provides a keyboard is integrated with peripheral or the personal article to provide expanded function. The keyboard has a joint and at least one transmission port. The joint is connected to a detachable coupling member on one side of the detachable coupling member. The peripheral or a personal article is connected to another side of the detachable coupling member. The peripheral can be card reader, loud speaker, wireless receiver, IR receiver, charger, fingerprint reader, video/audio acquisition means, handset port or PDA port. The personal article can be a radio, a clock or a photo frame. The keyboard with expanded function can enhance convenience and provide tidiness.

The various objects and advantages of the present invention will be more readily understood from the following detailed description when read in conjunction with the appended drawing, in which:

### BRIEF DESCRIPTION OF DRAWINGS

FIG. 1 shows an exploded view of the present invention;

FIG. 2 shows a sectional view of the present invention;

FIG. 3 shows a schematic view of the peripheral in the present invention;

FIG. 4 shows an exploded view of another embodiment of the present invention; and

FIG. 5 shows a schematic view of the personal article in the present invention.

### DETAILED DESCRIPTION OF THE INVENTION

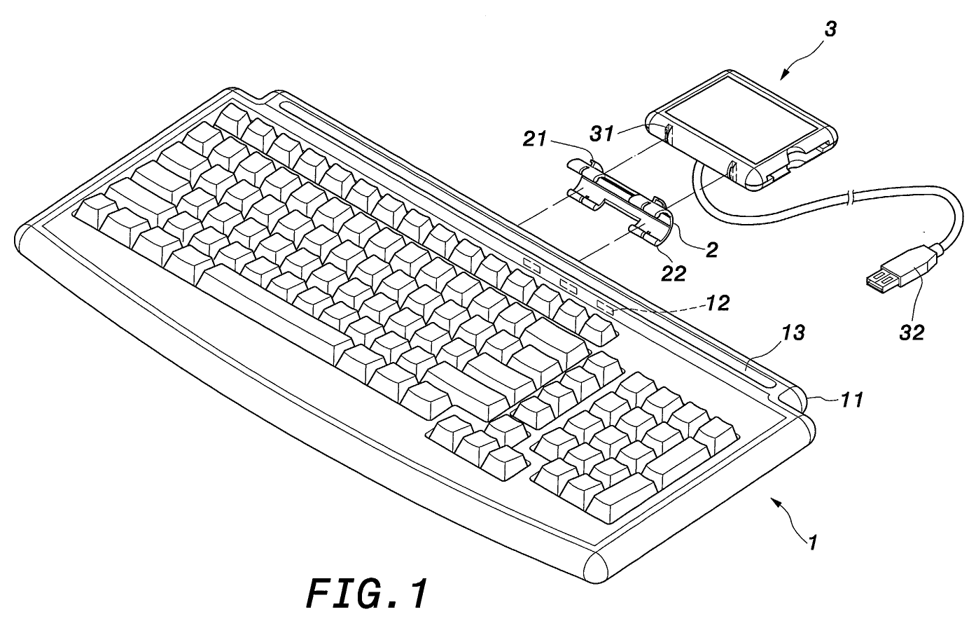

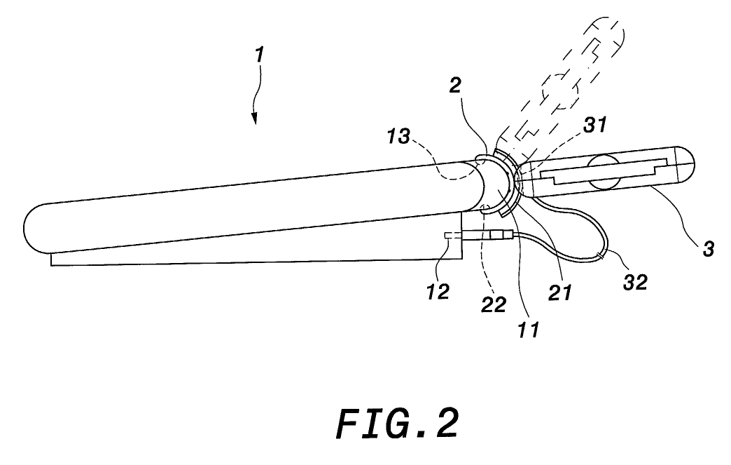

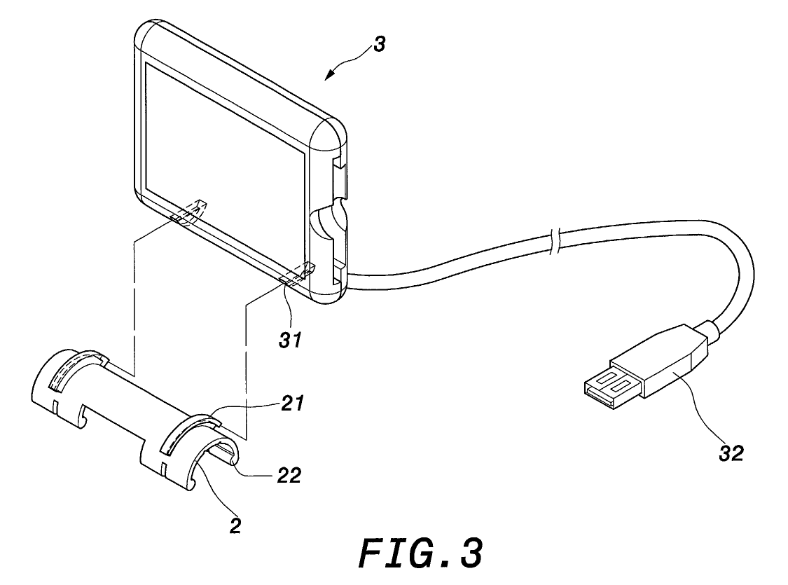

With reference now to FIGS. 1 to 3, the present invention is intended to provide a keyboard with expanded function. The keyboard according to a preferred embodiment of the present invention comprises a joint 11 and a transmission port 12 on a topside thereof. The joint 11 comprises a recess 13. The transmission port 12 has specification compatible with PS/2, USB, IEEE 1394 or RS-232. The joint 11 is connected to a detachable coupling member 2 on one side of the detachable coupling member 2. The detachable coupling member 2 is connected to a peripheral 3 on another side thereof. In the preferred embodiment of the present invention, the peripheral 3 is a card reader. However, the peripheral 3 can also be a loud speaker, a wireless receiver, an IR receiver, a charger, a fingerprint reader, a video/audio acquisition unit, a handset port or a PDA port. The coupling member 2 has at least one tenon 21 engaged into corresponding mortise 31 below the peripheral 3. The tenon 21 and the mortise 31 assemble the peripheral 3 to the coupling member 2 and enable the peripheral 3 to have angle adjustment. The coupling member 2 further has at least one locking part 22 engaged into corresponding recess 13 on the joint 11 such that the coupling member 2 and the peripheral 3 are assembled to the joint 11. More particularly, the coupling member 2 can be slidably moved on the joint 11. In the preferred embodiment of the present invention, the peripheral 3 is a card reader and has a connection wire 32 connected the transmission port 12 of the keyboard for data transmission.

The present invention provides an integral solution for the keyboard 1 and the peripheral 3. Moreover, peripheral 3 with other functions can also be integrated to the keyboard 1 for providing flexible function. Therefore, the peripherals 3 can be tidily arranged and the keyboard 1 is rendered with expanded function.

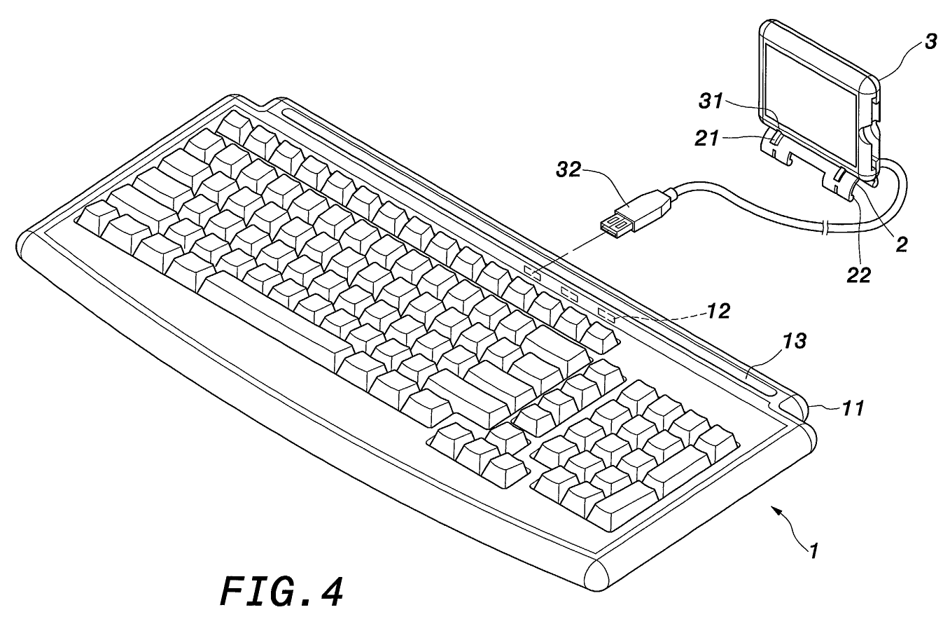

With reference to FIG. 4, the coupling member 2 is separated with the joint 11 of the keyboard 1 and assembled alone with the peripheral 3. Therefore, the coupling member 2 can be used as a mounting base of the peripheral 3.

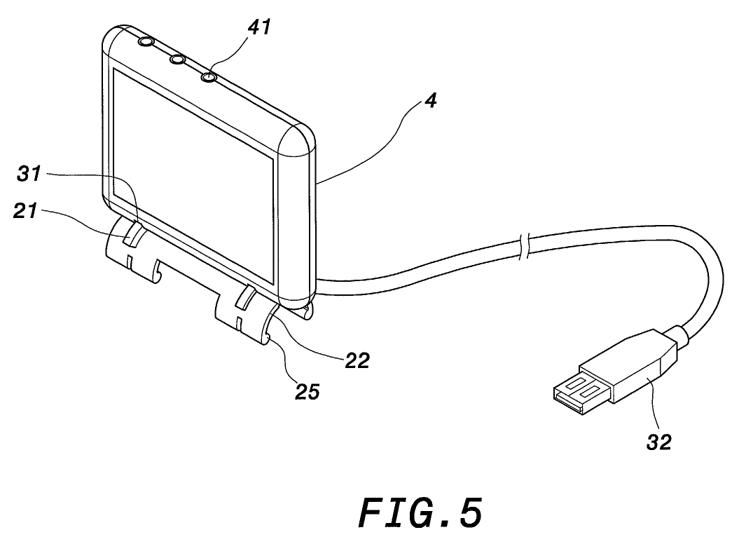

With reference to FIG. 5, the peripheral 3 is replaced by a personal article 4 such as a radio. The radio has at least one jacket for connecting to an earphone. Moreover, the personal article 4 can also be clock or photo frame.

To sum up, the keyboard with expanded function has following advantages:

(1) The peripheral and personal article can be easily integrated to the keyboard.

(2) Providing versatile functions of peripheral or personal article.

(3) Providing enhanced convenience and tidiness.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A keyboard with expanded function, comprising:
a keyboard having a joint and at least one transmission port, the joint connected to a detachable coupling member on one side of the detachable coupling member, and a peripheral or a personal article being connected to another side of the detachable coupling member.

2. The keyboard with expanded function as in claim 1, wherein the transmission port has specification compatible with PS/2, USB, IEEE 1394 or RS-232.

3. The keyboard with expanded function as in claim 1, wherein the peripheral has a connection wire connected the transmission port of the keyboard for data transmission.

4. The keyboard with expanded function as in claim 1, wherein the coupling member can be separated with the joint of the keyboard and assembled individually with the peripheral or the personal article such that the coupling member is functioned as a mounting base of the peripheral or the personal article.

5. The keyboard with expanded function as in claim 1, wherein the coupling member is slidable in a transversal direction of the joint

6. The keyboard with expanded function as in claim 1, wherein the coupling member is a locking part and the joint is a recess.

7. The keyboard with expanded function as in claim 1, wherein the coupling member has a tenon on bottom thereof and the peripheral has a mortise on bottom thereof and engaged with the tenon.

8. The keyboard with expanded function as in claim 1, wherein the coupling member has a tenon on bottom thereof and the personal article has a mortise on bottom thereof and engaged with the tenon.

9. The keyboard with expanded function as in claim 1, wherein the peripheral can be card reader, loud speaker, wireless receiver, IR receiver, charger, fingerprint reader, video/audio acquisition means, handset port or PDA port.

10. The keyboard with expanded function as in claim 1, wherein the personal article can be a radio, a clock or a photo frame.

11. The keyboard with expanded function as in claim 1, wherein the peripheral or the personal article has the flexibility of angle adjustment after being assembled with the coupling member.
